(19) United States
(12) Patent Application Publication
(10) Pub. No.: US 2019/0015953 A1
(43) Pub. Date: Jan. 17, 2019

(54) JIG FOR GRASPING WORKPIECE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: LI-CHIN LU, New Taipei (TW); LIU-JUN KONG, Shenzhen (CN); JIA-YU LV, Shenzhen (CN)

(21) Appl. No.: 15/844,632

(22) Filed: Dec. 18, 2017

(30) Foreign Application Priority Data
Jul. 14, 2017 (CN) 201710576571.3

(51) Int. Cl. B25B 5/16; B25B 5/02

(52) U.S. Cl. CPC B25B 5/163; B25B 5/006; B25B 5/02

(57) ABSTRACT

A jig for grasping a workpiece includes a first grasping member, a second grasping member, and a sliding assembly. The first grasping member includes a first holding portion and a second holding portion for holding opposite sides of a workpiece along a first direction. The second grasping member includes a first clamping portion and a second clamping portion for clamping or releasing opposite sides of the workpiece along a second direction. The sliding assembly is configured to slidably couple the first grasping member to the second grasping member.

### CROSS-REFERENCE TO RELATED APPLICATIONS

This application claims priority to Chinese Patent Application No. 201710576571.3 filed on Jul. 14, 2017, the contents of which are incorporated by reference herein.

### FIELD

The subject matter herein generally relates to a jig for grasping a workpiece.

### BACKGROUND

Generally, a workpiece, such as a consumer product or an electronic device, is packaged by hand.

### BRIEF DESCRIPTION OF THE DRAWINGS

Implementations of the present disclosure will now be described, by way of example only, with reference to the attached figures.

FIG. 1 is an assembled, isometric view of an exemplary embodiment of a jig for grasping a workpiece.

FIG. 2 is an isometric view of a first grasping member of the jig of FIG. 1.

FIG. 3 is an isometric view of a second grasping member of the jig of FIG. 1.

FIG. 4 is an exploded view of the second grasping member of FIG. 3.

FIG. 5 is a cross-sectional view of the jig of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

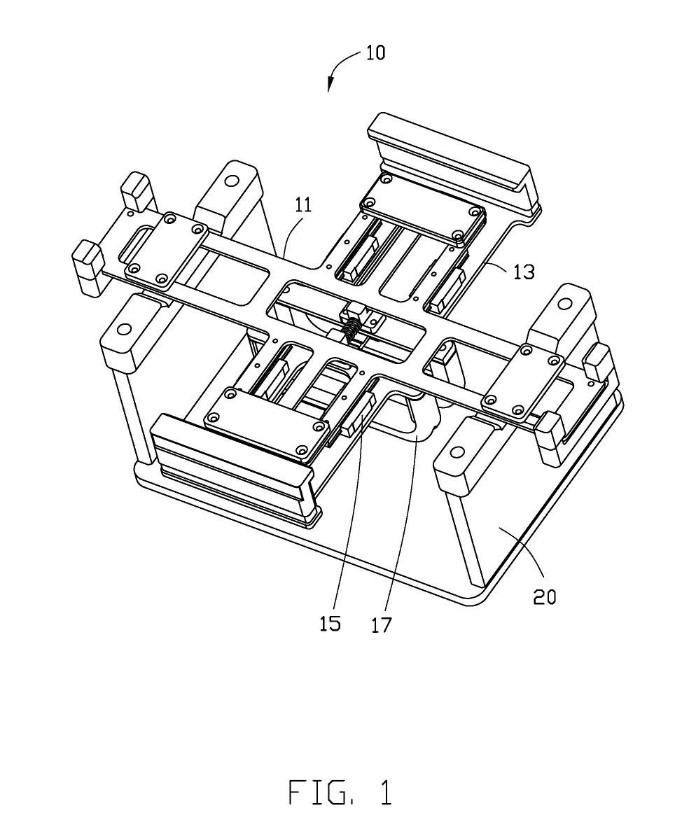

FIG. 1 illustrates an embodiment of a jig 10. In at least one embodiment, the jig 10 is used during a process of cleaning and packaging a workpiece. The jig 10 can grasp, turn over, and release a workpiece. The jig 10 can include a first grasping member 11, a second grasping member 13, and a sliding assembly 15. In at least one embodiment, a work table 20 can be provided to support the jig 10 thereon.

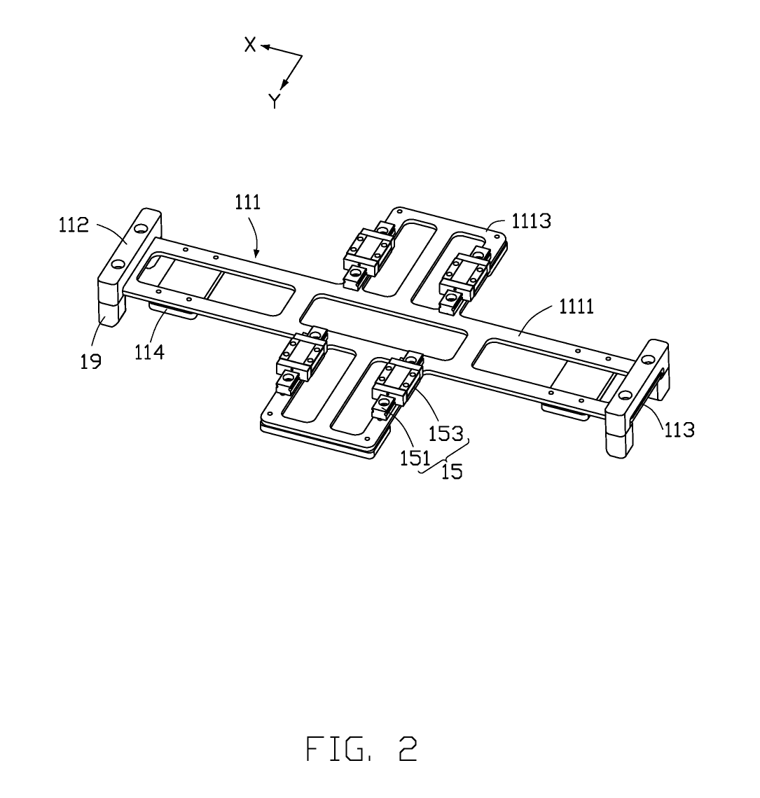

Referring to FIG. 2, the first grasping member 11 can include a first frame 111, a first holding portion 112, and a second holding portion 113. The first frame 111 can be substantially cross-shaped and include a portion extending along a first direction 1111 and a portion extending along a second direction 1113. The first direction 1111 is substantially perpendicular to the second direction 1113. In at least one embodiment, the first direction 1111 is defined as an X-axis direction, and the second direction 1113 is defined as a Y-axis direction. In at least one embodiment, the first frame 111 is made of aluminum.

The first holding portion 112 and the second holding portion 113 are arranged at opposite sides of the first frame 111 along the first direction 1111. The first holding portion 112 and the second holding portion 113 are substantially parallel to each other and substantially perpendicular to the first frame 111. In at least one embodiment, the first holding portion 112 and the second holding portion 113 are fixed to the first frame 111 by screws. The first holding portion 112 and the second holding portion 113 can cooperatively hold opposite sides of a workpiece along the first direction 1111.

The first holding portion 112 and the second holding portion 113 can each include a protective cover 19. The protective cover 19 can prevent scuff marks and damage on the workpiece when held by the first holding portion 112 and the second holding portion 113. In at least one embodiment, the protective cover 19 is made of antistatic silica gel.

In at least one embodiment, the first grasping member 11 includes at least one separating block 114. The separating block 114 can be used for preventing static between the first frame 111 and the workpiece. In at least one embodiment, the separating block 114 is made from plastic steel.

The sliding assembly 15 is arranged between the first grasping member 11 and the second grasping member 13. The sliding assembly 15 slidably couples the second grasping member 13 to the first grasping member 11. The sliding assembly 15 can include a sliding rail 151 and a sliding block 153.

The sliding rail 151 is arranged on a bottom surface of the first frame 111. The sliding rail 151 can be arranged along the second direction 1113 on the first frame 111. In at least one embodiment, there are four sliding rails 13. The sliding rails 151 are arranged in two lines along the second direction, each line having two corresponding sliding rails 151. In at least one embodiment, the sliding rails 151 are fixed to the first frame 111 by screws.

The sliding block 153 is slidably coupled to the sliding rail 151. Each sliding rail 151 has a corresponding sliding block 153. The sliding block 153 is coupled to the second grasping member 13 to slidably coupled the second grasping member 13 to the first grasping member 11.

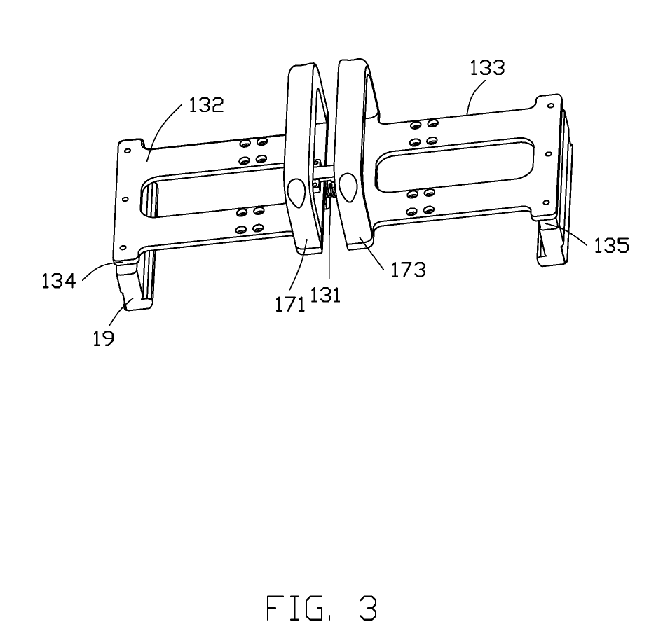

Referring to FIG. 3, the second grasping member 13 can include a connector 131, a second frame 132, a third frame 133, a first clamping portion 134, and a second clamping portion 135.

A size and shape of the second frame 132 can be substantially the same as a size and shape of the third frame 133. The connector 131 is arranged between the second frame 132 and the third frame 133 to couple the second frame 132 and the third frame 133 together. The second grasping member 13 can be substantially rectangular. One side of the sliding block 153 is slidably coupled to the sliding rail 151, and another side of the sliding block 153 can be fixed to the second grasping member 13 by screws.

The first clamping portion 134 is arranged at an end of the second frame 132 away from the connector 131, and the second clamping portion 135 is arranged at an end of the third frame 133 away from the connector 131. The first clamping portion 134 and the second clamping portion 135 are arranged opposite to each other and are perpendicular to the second frame 132 and the third frame 133. In at least one embodiment, the first clamping member 134 and the second clamping member 135 can be fixed to the second frame 132 and the third frame 133 by screws.

In at least one embodiment, the first clamping member 134 and the second clamping member 135 can include the protection cover 19 for preventing scuff marks and damage on the workpiece.

The connector 131 is elastically coupled between the second frame 132 and the third frame 133. A width of the second grasping member 13 can be adjusted to grasp workpieces of different sizes.

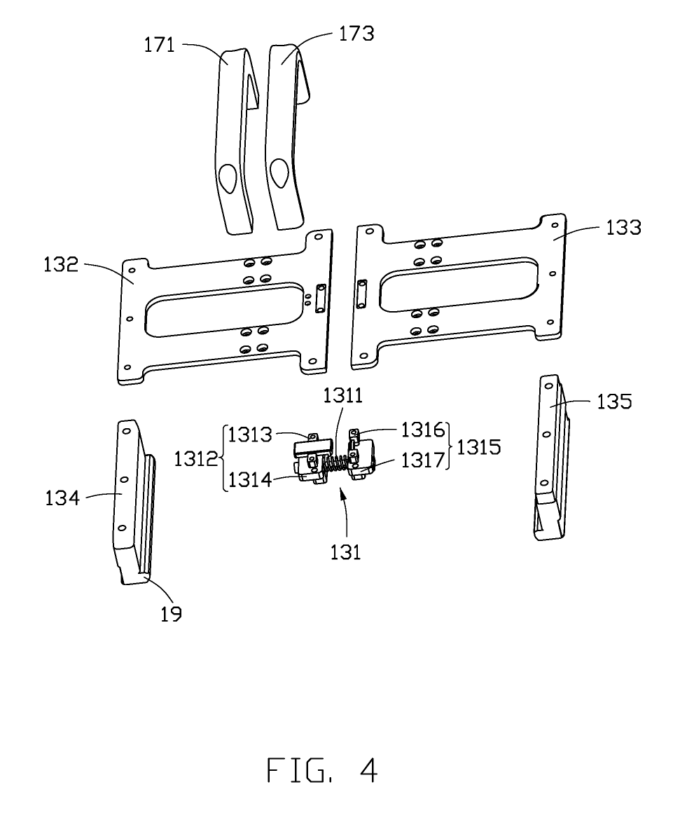

Referring to FIG. 4, the connector 131 can include a connecting portion 1311, a first latching assembly 1312, and a second latching assembly 1315. The first latching assembly 1312 can include a first mounting seat 1314 and a first latching member 1313 coupled to the first mounting seat 1314. In at least one embodiment, the first mounting seat 1313 and the first latching member 1313 cooperatively clamp an end of the second frame 132. For instance, the first latching member 1313 can be arranged on a side of the second frame 132 away from the first grasping member 11, and the first mounting seat 1314 can be arranged on a side of the second frame 132 opposite to the first latching member 1313. The first latching member 1313 can include a hook portion and a releasing portion. The hook portion extends toward the third frame 133 to latch with the second latching portion 1315. The releasing portion can be pressed to unlatch the hook portion from the first latching portion 1315.

The second latching assembly 1315 can include a second mounting seat 1317 and a second latching member 1316 coupled to the second mounting seat 1317. In at least one embodiment, the second latching member 1316 and the second mounting seat 1317 cooperatively clamp an end of the third frame 133. For instance, the second latching member 1316 can be arranged on a side of the third frame 133 away from the first grasping member 11, and the second mounting seat 1317 can be arranged on a side of the third frame 133 opposite to the second latching member 1316.

The connecting portion 1311 can be a spring coupled between the first mounting seat 1314 and the second mounting seat 1317. By latching and unlatching the first latching member 1312 from the second latching member 1315, the second frame 132 and the third frame 133 can be moved together or away from each other. When the first latching member 1312 is latched to the second latching member 1315, the second frame 132 and the third frame 133 are moved together, and the workpiece can be grasped. When the first latching member 1312 is released from the second latching member 1315, the second frame 132 and the third frame 133 are moved away from each other, and the workpiece can be released.

The jig 10 can further include a control assembly 17. The control assembly 17 can include a first controlling member 171 and a second controlling member 173. The control assembly 17 can move together the first clamping portion 134 and the second clamping portion 135 to grasp opposite sides of the workpiece along the second direction 1113. In detail, the first controlling member 171 is coupled to the second frame 132 adjacent to the first latching member 1313, and the second controlling member 173 is coupled to the third frame 133 adjacent to the second latching member 1316. In at least one embodiment, the first controlling member 171 and the second controlling member 173 are handles.

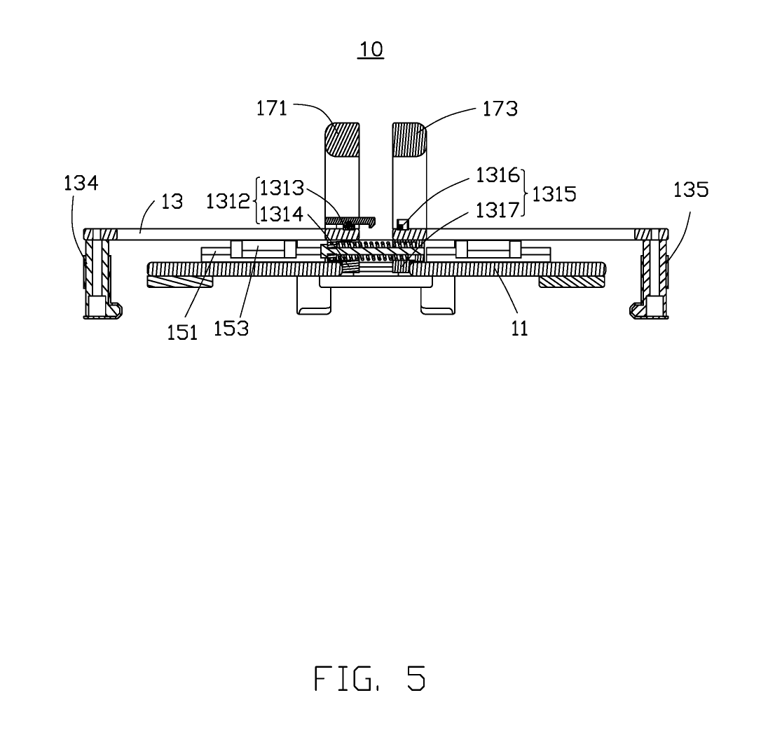

Referring to FIG. 5, when the first controlling member 171 and the second controlling member 173 are manually operated, the first controlling member 171 and the second controlling member 173 are moved closer together. The first controlling member 171 can move the sliding blocks 153 coupled to the second frame 132 along the sliding rails 151 toward the second latching member 1316, and the second controlling member 173 can move the sliding blocks 153 coupled to the third frame 133 along the sliding rails 151 toward the first latching member 1313, until the first latching member 1313 latches with the second latching member 1316, and the workpiece can be grasped along the second direction 1113. The first holding portion 112 and the second holding portion 113 can hold the workpiece along the first direction 1111.

To release the workpiece from the jig 10, the releasing portion of the first latching member 1313 can be pressed to release the first latching member 1313 from the second latching member 1316.

By using the jig 10 as described above, the control assembly 17 can be manually operated to control the second grasping member 13 to grasp the workpiece in cooperation with the first grasping member 11. The first latching member 1312 and the second latching member 1315 can be easily latched together and released to realize grasping and release of the workpiece.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A jig for grasping a workpiece, the jig comprising:
a first grasping member comprising a first holding portion and a second holding portion for holding opposite sides of a workpiece along a first direction;
a second grasping member comprising a first clamping portion and a second clamping portion for clamping or releasing opposite sides of the workpiece along a second direction; and
a sliding assembly configured to slidably couple the first grasping member to the second grasping member.

2. The jig of claim 1, wherein the first grasping member comprises a first frame comprising a portion extending along a first direction and a portion extending along a second direction; the first direction is perpendicular to the second direction; the first holding portion and the second holding portion are located at opposite ends of the first direction.

3. The jig of claim 1, wherein the second grasping member comprises a second frame, a third frame, and a connector; the connector is between the second frame and the third frame; the first clamping portion is located on the second frame and is located at an end of the second frame away from the connector; the second clamping portion is located on the third frame and is located at an end of the third frame away from the connector; the first clamping portion and the second clamping portion are perpendicular to the second frame and the third frame.

4. The jig of claim 3, wherein the connector comprises a connecting portion, a first latching assembly, and a second latching assembly; the connecting portion is resiliently coupled between the first latching assembly and the second latching assembly; the first latching assembly is located at an end of the second frame away from the first clamping portion; the second latching assembly is located at an end of the third frame away from the second clamping portion; the first latching assembly and the second latching assembly releasably latch together.

5. The jig of claim 4, wherein the first latching assembly comprises a first mounting seat and a first latching member coupled to the first mounting seat; the first mounting seat and the first latching member cooperatively clamp an end of the second frame.

6. The jig of claim 5, wherein the second latching assembly comprises a second mounting seat and a second latching member coupled to the second mounting seat; the second mounting seat and the second latching member cooperatively clamp an end of the third frame.

7. The jig of claim 6 further comprising a control assembly that when grasped manually is configured to move the second and third frame together along the second direction; the control assembly comprises a first controlling member and a second controlling member; the first controlling member is coupled to the second frame, and the second controlling member is coupled to the third frame.

8. The jig of claim 7, wherein when the second and third frame are moved together by the control assembly, the first latching member latches with the second latching member to hold the second frame and the third frame together; the connecting portion is compressed when the second frame and the third frame are held together.

9. The jig of claim 8, wherein the first latching member is pressed to release the first latching member from the second latching member; when the first latching member is released from the second latching member, the connecting portion resiliently restores to move the second frame and the third frame away from each other.

10. The jig of claim 3, wherein a size and shape of the second frame is the same as a size and shape of the third frame.

11. The jig of claim 2, wherein the sliding assembly comprises a sliding rail and a sliding block; the sliding block is slidably coupled to the sliding rail; the sliding rail is located on the first frame; the sliding block couples the second grasping member to the first frame.

12. The jig of claim 1, wherein the first holding portion, the second holding portion, the first clamping portion, and the second clamping portion comprise a protective cover.
